(19) United States
(12) Patent Application Publication
(10) Pub. No.: US 2020/0064313 A1
(43) Pub. Date: Feb. 27, 2020

(54) STATOR ARRAY FOR A MULTI-VALVE SYSTEM

(71) Applicant: Waters Technologies Corporation, Milford, MA (US)

(72) Inventors: Sylvain Gilles Cormier, Mendon, MA (US); Charles H. Phoebe, Jr., Uxbrige, MA (US); Jason F. Hill, Milford, MA (US); James P. Murphy, III, Franklin, MA (US)

(21) Appl. No.: 16/545,540

(22) Filed: Aug. 20, 2019

Related U.S. Application Data
(60) Provisional application No. 62/720,548, filed on Aug. 21, 2018.

(51) Int. Cl. G01N 30/20; F16K 99/00

(52) U.S. Cl. CPC G01N 30/20; G01N 2030/027; F16K 99/0013

(57) ABSTRACT

Described are stator arrays for multi-valve systems used in different chromatographic applications. Also described is a mounting assembly for a multi-valve system that includes the stator array. Each stator array has a stator body having a first stator surface and a second stator surface. Each stator surface has a plurality of stator ports and is configured to engage a rotor surface of a rotary valve actuator. A fluid channel inside the stator body couples one of the stator ports of the first stator surface to one of the stator ports of the second stator surface. The fluid channel may be a microfluidic channel. A solid-state diffusion bonding process in which two or more parallel layers of material are joined together may be used to fabricate the stator body. Complex fluid channel networks may be formed using many fluid channels formed in multiple layers within the stator body.

### CROSS REFERENCE TO RELATED APPLICATIONS

This application claims the benefit of and priority to co-pending U.S. Provisional Patent Application No. 62/720,548, filed Aug. 21, 2018, titled “STATOR ARRAY FOR A MULTI-VALVE SYSTEM”, the entirety of which is incorporated by reference herein.

### FIELD OF THE INVENTION

The invention relates generally to multi-valve fluidic systems. More particularly, the invention relates to a stator array having microfluidic channels formed in a diffusion bonded body which can be used in a multi-valve liquid chromatography system.

### BACKGROUND

Liquid chromatography systems often include multiple valves coupled to each other with tubes to achieve a desired fluidic path configuration. A large number of tubes may be connected between the valves to establish the desired fluidic path configuration. The connections required to connect the tubing can have unswept volumes that may result in carryover and cross-contamination. Moreover, the large number of connections increases the chance of leakage and significant time is typically required to manually install the tubing and complete the connections.

Each tube has a volume that can vary substantially from the desired tube volume due to the large physical tolerance for the inner diameter (ID) of the tube. Thus, the chromatographic results obtained with one chromatographic system may differ markedly from the results obtained with a similar chromatographic system due to the differences in the tube volumes according to the ID manufacturing tolerances. For example, a valve configuration may be used to acquire samples or “cuts” of samples from a first liquid chromatography system for injection into a second dimension chromatography system. Alternatively, valves may be configured to consecutively sample different volumes of the same sample into different sample loops. Use of this configuration allows a smaller volume of acquired sample to be used if it is determined that an initial sample volume results in high mass loading and/or detector saturation problems. In another alternative, complex valve configurations may be used to provide an identical sample to different single-dimension chromatography systems to acquire more information about the sample than can be acquired from a single chromatography system. Each of the above valve configurations can be adversely affected by the variation in tube volumes and large number of tube connections that can leak and require significant set up time.

### SUMMARY

Embodiments of the present disclosure include a stator array. The stator array may be used as part of a multi-valve array in which two or more rotary valves share a stator body that includes a stator surface for each valve.

In one example, a stator array includes a stator body having a first stator surface and a second stator surface separated from the first stator surface. Each of the first and second stator surfaces is configured to engage a rotor surface of a rotary valve and has a plurality of stator ports. The stator body has a first fluid channel inside the stator body that couples one of the stator ports of the first stator surface to one of the stator ports of the second stator surface. The first fluid channel may be a microfluidic channel.

The stator body may have an external surface separated from the first and second stator surfaces and a second fluid channel coupling a port on the external surface to one of the stator ports of one of the first and second stator surfaces. The stator body may include a plurality of diffusion bonded layers and the stator body may have a plurality of fluid channels each defined in a diffusion bonded layer, wherein one of the fluid channels is in a diffusion bonded layer that is different from the diffusion bonded layer of at least one of the other fluid channels. At least one of the fluid channels may be defined in at least two diffusion bonded layers.

The stator array may further include a first rotary valve actuator having a first rotor surface abutting the first stator surface and a second rotary valve actuator having a second rotor surface abutting the second stator surface.

In another example, a stator array includes a stator body having a plurality of internal fluid channels comprising a plurality of first sample channels, a plurality of second sample channels, a first and a second inlet channel, and a first and a second outlet channel. The stator body has a first stator surface, a second stator surface and third stator surface with each surface having a plurality of stator ports. Each of the first sample channels couples one of the stator ports of the second stator surface to another one of the stator ports of the second stator surface. Each of the second sample channels couples one of the stator ports of the third stator surface to another one of the stator ports of the third stator surface. The first inlet channel and the first outlet channel each couple one of the stator ports of the second stator surface to one of the stator ports of the first stator surface. The second inlet channel and the second outlet channel each couple one of the stator ports of the third stator surface to one of the stator ports of the first stator surface.

The stator array may further include a first rotary valve actuator having a first rotor surface abutting the second stator surface and a second rotary valve actuator having a second rotor surface abutting the third stator surface. The first and second rotary valve actuators may be rotary shear seal valve actuators. The stator array may further include a third rotary valve actuator having a third rotor surface abutting the first stator surface.

The stator body may include a plurality of diffusion bonded layers.

Each of the first and second sample channels may have a volume that is equal the volume of each of the other first and second sample channels.

The stator array may further include a first dimension outlet channel, a second dimension inlet channel, a second dimension outlet channel and a waste channel each being inside the stator body and each coupling a stator port of the first stator surface to an external port on the stator body.

In another example, a stator array includes a stator body having a plurality of internal fluid channels, an external surface, a first stator surface having a plurality of stator ports and a second stator surface having a plurality of stator ports. The plurality of internal fluid channels includes a chromatography system inlet channel coupling one of the stator ports of the first stator surface to a first external port on the external surface, a chromatography system outlet channel coupling another one of the stator ports on the first stator surface to a second external port on the external surface, a first sample loop coupling a first pair of the stator ports of the first stator surface, a second sample loop coupling a second pair of stator ports on the second stator surface, and a sample channel coupling one of the ports of the first stator surface to one of the ports of the second stator surface. The sample channel conducts a sample between the first and second stator surfaces during a sample load operation. The stator body may include a plurality of diffusion bonded layers.

The stator array may further include a first rotary valve actuator having a first rotor surface abutting the first stator surface and a second rotary valve actuator having a second rotor surface abutting the second stator surface. The first stator surface and the first rotary valve actuator may be configured as a first rotary shear seal valve and the second stator surface and the second rotary valve actuator may be configured as a second rotary shear seal valve.

In another example, a stator array includes a stator body having a plurality of internal fluid channels, an external surface, a first stator surface having a plurality of stator ports and a second stator surface having a plurality of stator ports. The plurality of internal fluid channels includes a first chromatography system inlet channel coupling one of the stator ports on the first stator surface to a first external port on the external surface, a first chromatography system outlet channel coupling another one of the stator ports of the first stator surface to a second external port on the external surface, a second chromatography system inlet channel coupling one of the stator ports of the second stator surface to a third external port on the external surface, a second chromatography system outlet channel coupling another one of the stator ports of the second stator surface to a fourth external port on the external surface, and a sample channel coupling one of the stator ports on the first stator surface to one of the stator ports on the second stator surface. The sample channel conducts a sample between the first and second stator surfaces during a sample load operation. The stator body may include a plurality of diffusion bonded layers.

The stator array may further include a first sample loop coupling a first pair of the stator ports of the first stator surface and a second sample loop coupling a second pair of the stator ports of the second stator surface. The first sample loop and the second sample loop may be an internal sample channel or an external sample loop. A volume of the first sample loop may be different than a volume of the second sample loop.

The stator array may further include a first rotary valve actuator having a first rotor surface abutting the first stator surface and a second rotary valve actuator having a second rotor surface abutting the second stator surface.

In another example, a mounting assembly for a stator array includes a mounting frame, a retainer element and a plurality of spring elements. The mounting frame has a first wall with a plurality of openings and a second wall that is opposite to the first wall. Each of the openings is configured to pass a portion of a valve pod attached to a stator body. The retainer element is attached to the mounting frame and is configured to apply a force against a surface of the stator body so that the stator body is held fixed against the first wall and at least a portion of each of the valve pods extends through a respective one of the openings in the first wall. Each spring element is disposed against the second wall in a position opposite to a respective one of the openings in the first wall. Each spring element is configured to apply a force to a valve drive to urge the valve drive away from the second wall and toward the first wall.

The spring elements may be compression springs. The retainer clip may be a spring clip or a toggle clip.

The mounting frame may have a plurality of third walls such that each of the third walls extends between the first and second wall and has a slot extending along a portion of a length of the third wall. The mounting assembly may further include the stator body. The mounting assembly may further include a valve drive disposed between one of the spring elements and one of the valve pods attached to the stator body and may further include at least one screw extending from the valve drive and in engagement with the slot in an adjacent one of the third walls.

### BRIEF DESCRIPTION OF THE DRAWINGS

The above and further advantages of this invention may be better understood by referring to the following description in conjunction with the accompanying drawings, in which like reference numerals indicate like elements and features in the various figures. For clarity, not every element may be labeled in every figure. The drawings are not necessarily to scale, emphasis instead being placed upon illustrating the principles of the invention.

FIG. 1A is a top view of an embodiment of a stator body.

FIG. 1B is a cutaway side view of the stator body of FIG. 1A.

FIG. 2 is a diagram of a multi-valve array for acquiring samples from a chromatography system in a first chromatographic dimension for injection into a second chromatography system of a second chromatographic dimension.

FIG. 3A is a top view of an example of a stator body that can be used as part of a multi-valve array to replace the multi-valve array of FIG. 2.

FIG. 3B shows the stator body of FIG. 3A; however, the body material is depicted as transparent so that internal fluid channels are visible.

FIG. 3C is a perspective view of the transparent stator body of FIG. 3B depicting the four discrete layers used in the diffusion bonding process to fabricate the stator body.

FIG. 4A is a top view of an example of a stator body that can be used in a multi-valve array for acquiring different volumes of sample for a chromatographic injection.

FIG. 4B is a transparent top view of the stator body of FIG. 4A.

FIG. 4C is transparent bottom perspective view of the stator body of FIG. 4A.

FIG. 4D is an expanded view of the central portion of FIG. 4B

FIG. 5A is a top view of another example of a stator body that that can be used in a multi-system injector array.

FIG. 5B is a transparent top view of the stator body of FIG. 5A.

FIG. 5C is a transparent bottom perspective view of the stator body of FIG. 5A.

FIG. 5D is an expanded view of the central portion of FIG. 5B.

FIG. 6A is a top front perspective view of an example of a multi-valve array.

FIG. 6B is a top perspective back view of the example of a multi-valve array of FIG. 6A.

FIG. 7 is a mounting assembly for the multi-valve array of FIGS. 6A and 6B.

FIG. 8A is a perspective view of an example of a retainer element for the mounting assembly of FIG. 7.

FIG. 8B is a side view of the retainer element of FIG. 8A.

FIG. 8C is a top view of the retainer element of FIG. 8A.

### DETAILED DESCRIPTION

Reference in the specification to “one embodiment” or “an embodiment” means that a particular feature, structure or characteristic described in connection with the embodiment is included in at least one embodiment of the teaching. References to a particular embodiment within the specification do not necessarily all refer to the same embodiment.

In brief overview, embodiments disclosed herein are directed to a stator array that includes a stator body having two or more stator surfaces and directed to a mounting assembly for the stator array. Each stator surface is configured to engage and seal against a rotor surface of a corresponding rotary valve. Each stator surface includes stator ports to communicate with rotor ports. There is at least one fluid channel inside the stator body that couples a stator port in one of the stator surfaces (i.e., stator “faces”) with a stator port in another one of the stator surfaces.

The stator array avoids the need to use a large number of tubes to provide fluidic connections between two or more rotary valves. Instead, stator ports in different stator surfaces are internally coupled to each other within a single block that includes the stator surfaces for the rotary valves. By eliminating most of the tubing connections, the array is more robust and leaks and possible contamination points are significantly reduced. In addition, dispersion is significantly reduced as the unswept volumes associated with tubing connectors are eliminated. The block can be fabricated from individual layers of material using a diffusion bonding technique. Use of the stator body reduces the complexity and time required to set up various chromatographic instrument configurations because most of the fluidic connections are contained inside the stator array block. The multi-valve array can be used for a number of applications including, for example, improving interloop volume accuracy for the collection of samples for injection into a second chromatographic dimension. Additionally, the stator array has improved volume characteristics for the internal sample channels as compared to conventional external sample loops.

The present teaching will now be described in more detail with reference to embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill having access to the teaching herein will recognize additional implementations, modifications and embodiments, as well as other fields of use, which are within the scope of the present disclosure.

The embodiments described below include the use of a multi-valve array in which two or more rotary valves share a stator body (i.e., stator “block”) that includes a stator surface for each valve. For example, the rotary valves may be rotary shear seal valves in which each valve has a rotor surface that is parallel to and in contact with one of the stator surfaces. Each rotor surface is configured to rotate about an axis that is orthogonal to the rotor surface and the corresponding stator surface on the stator block during valve switching to reconfigure the communicaton of fluid flow paths coupled to the valve. In some examples, multiple sample loops in the multi-valve array may used in a process to acquire sample slices from chromatographic peaks in the eluent of a first dimension chromatography system and subsequenty inject the sample slices into a second dimension chromatography system. For example, multiple slices of a peak may be acquired if there is a possibility that the sample composition across a peak is not constant. In other examples, multiple sample loops within the block having different volumes may be loaded with sample, potentially eliminating the need for partial loading of a sample loop having a larger volume.

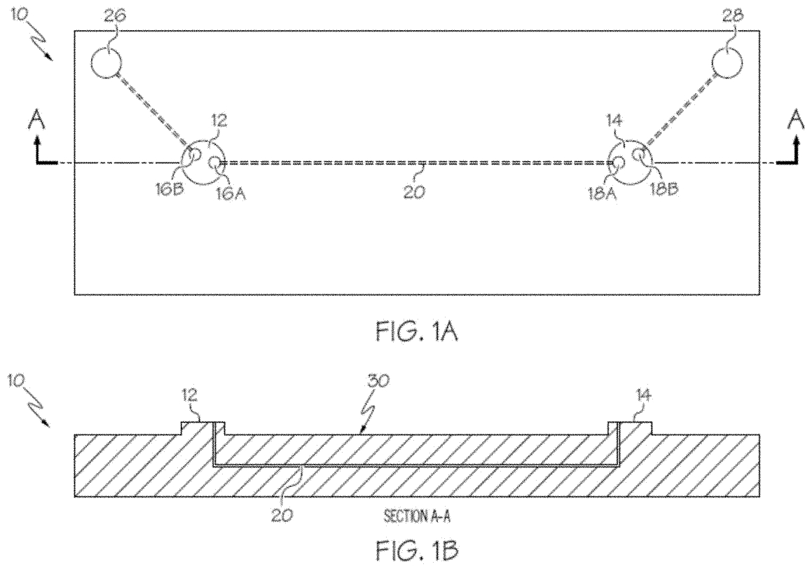

FIGS. 1A and 1B show a top down view and a cutaway side view, respectively, of an embodiment of a stator body 10 having a first stator surface 12 and a second stator surface 14. When assembled as a rotary valve array, each stator surface engages a rotor surface of a corresponding actuator potion of a rotary valve. In the figure, only two stator ports 16 and 18 are indicated on each stator surface 12 and 14, respecitvley. One set of stator ports 16A and 18A are provided at the end of a fluid channel 20 that extends between the two stator surfaces 12 and 14. The fluic channel 20 is shown as a dashed line in FIG. 1A as it is inside the stator body 10. The other stator ports 16B and 18B are at one end of fluid channels 22 and 24, respectively, which terminate at their other ends at an external ports 26 and 28, respectively, at an external surface 30 of the stator body. The external ports 26 and 28 may be configured to couple to tubing or other form of external channel using, for example, a fitting at an end of the tubing. Although the stator surfaces 12 and 14 are despicted as two regions raised above the external surface 30, in other embodiments the external suface 30 may be at a simlar or greater height as long as there is a separation between the stator surfaces 12 and 14 from the neighboring regions of the external surface 30 so that the rotary valves may operate properly and not interfere with each other. The minimum separation between the stator surfaces 12 and 14 may be limited according to the dimensions of the upper sections of the rotary valves which includes the actuator portions and rotors, and which are secured to the stator body 10 using bolts or other attachment means.

In other embodiments, more complex fluid channel routing may be used with greater numbers of internal fluid channels and/or external ports on the external surface of the stator body. In still other examples, there may be greater numbers of stator surfaces to accommodate a greater number of rotary valves. In some embodiments, the fluid channels are microfluidic channels. For example, the fluid channels may have volumes of a few microliters or less.

The stator body 10 may be fabricated as a single plate using a solid-state diffusion bonding process in which two or more parallel layers of material are joined together. The layers are forced against each other under pressure at an elevated temperture (e.g., a temperature in a range of about 50% to 90% of the absolute melting point of the material) for a duration ranging from a few minutes to several hours). The pressure and temperature are then reduced before repeating one or more additional cycles at the elevated temperature and pressure. Examples of materials used to create the diffusion-bonded stator body include titanium, stainless steel, and various types of ceramics and polymers.

The diffusion bonding process may be performed where one or more of the layers has a channel formed along a surface that will abut an adjacent surface of a neighboring layer. These internal or “embedded” channels, along with vertical channels formed at their ends, define fluid channels used to communicate fluids between the rotors and inlets and outlet on the external surface 30 of the stator body 10. Depending on the number of layers, a large number of fluid channels may be formed in the stator body 10. In some embodiments, the fluid channels are defined between different layers at different depths so that some fluid channels may cross above or below other fluid channels to avoid interference and to allow for complex fluid channel configurations.

When performing two-dimensional chromatography using conventional rotary valves, external tubing is typically used for the sample loops. Each tube requires a connection at each end to one of the rotary valves. Generally, it is desirable to have each sample loop hold the same volume of liquid as the other sample loops. For small sample volumes, the length of the tubing can be reduced; however, there is a fundamental limit to reducing the length as the tubing is required to bridge between its coupling ports on the valve. The inner diameter (ID) of the tubing can be reduced to achieve a smaller sample loop volume. However, due to the manufacturing tolerance on the ID, the variations in volume for what are intended to be equivalent volume sample loops becomes an increasingly larger percentage of the desired sample loop volume with decreasing ID.

Table 1 lists the nominal, minimum and maximum volumes associated with different external sample loop IDs and lengths according to different manufacturing tolerances for the ID and length. It can be seen that the greatest percentage variations in volume are associated with the smallest sample loop volumes.

TABLE 1
ACQUITY HYPO SAMPLE LOOPS

| Hypo Sample Loop | Nominal | | | Nominal | | | Nominal | Minimum | Maximum |
|---|---|---|---|---|---|---|---|---|---|
| Size (uL) | ID (in) | Tolerance+ | Tolerance− | Length (in) | Tolerance+ | Tolerance− | Volume (uL) | Volume (uL) | Volume (uL) |
| 1 | 0.004 | 0.0005 | 0.0005 | 5.00 | 0.03 | 0.03 | 1.03 | 0.78 | 1.32 |
| 2 | 0.004 | 0.0005 | 0.0005 | 9.75 | 0.03 | 0.03 | 2.01 | 1.53 | 2.55 |
| 5 | 0.007 | 0.0005 | 0.0005 | 7.95 | 0.03 | 0.03 | 5.01 | 4.31 | 5.78 |
| 10 | 0.010 | 0.0005 | 0.0005 | 7.79 | 0.03 | 0.03 | 10.03 | 9.01 | 11.10 |

ACQUITY SAMPLE LOOPS

| Sample Loop | Nominal | | | Nominal | | | Nominal | Minimum | Maximum |
|---|---|---|---|---|---|---|---|---|---|
| Size (uL) | ID (in) | Tolerance+ | Tolerance− | Length (in) | Tolerance+ | Tolerance− | Volume (uL) | Volume (uL) | Volume (uL) |
| 1 | 0.004 | 0.001 | 0.001 | 5.00 | 0.03 | 0.03 | 1.03 | 0.58 | 1.62 |
| 2 | 0.005 | 0.001 | 0.001 | 6.20 | 0.03 | 0.03 | 1.99 | 1.27 | 2.89 |
| 5 | 0.007 | 0.001 | 0.001 | 7.93 | 0.03 | 0.03 | 5.00 | 3.66 | 6.56 |
| 10 | 0.012 | 0.001 | 0.001 | 5.40 | 0.03 | 0.03 | 10.01 | 8.36 | 11.81 |
| 10 - Bent | 0.012 | 0.001 | 0.001 | 5.40 | 0.03 | 0.03 | 10.01 | 8.36 | 11.81 |
| 20 | 0.012 | 0.001 | 0.001 | 10.79 | 0.03 | 0.03 | 20.00 | 16.76 | 23.53 |
| 50 | 0.020 | 0.000 | 0.002 | 9.76 | 0.06 | 0.06 | 50.25 | 40.45 | 50.55 |
| 100 | 0.030 | 0.000 | 0.002 | 8.63 | 0.06 | 0.06 | 99.96 | 86.47 | 100.66 |
| 250 | 0.030 | 0.000 | 0.002 | 21.59 | 0.06 | 0.06 | 250.08 | 217.25 | 250.78 |

In contrast, Table 2 shows the nominal, minimum and maximum volumes associated with different sample loops that can be formed in a diffusion-bonded body, such as the stator body 10 described with respect to FIGS. 1A and 1B. The smaller manufacturing tolerances for ID and length result in significantly better control of the volume for small sample loops. Thus, a diffusion-bonded stator body can have smaller sample volumes than can be achieved with external sample loops while having the additional advantage of more accurate volume control.

TABLE 2
DIFFUSION BONDED LOOPS

| Sample Loop | Nominal | | | Nominal | | | Nominal | Minimum | Maximum |
|---|---|---|---|---|---|---|---|---|---|
| Size (uL) | ID (in) | Tolerance+ | Tolerance− | Length (in) | Tolerance+ | Tolerance− | Volume (uL) | Volume (uL) | Volume (uL) |
| 1 | 0.010 | 0.00005 | 0.00005 | 0.78 | 0.00005 | 0.00005 | 1.000 | 0.990 | 1.010 |
| 2 | 0.010 | 0.00005 | 0.00005 | 1.55 | 0.00005 | 0.00005 | 2.000 | 1.980 | 2.020 |
| 5 | 0.010 | 0.00005 | 0.00005 | 3.89 | 0.00005 | 0.00005 | 5.000 | 4.958 | 5.050 |
| 10 | 0.012 | 0.00005 | 0.00005 | 5.40 | 0.00005 | 0.00005 | 10.008 | 9.925 | 10.092 |
| 20 | 0.012 | 0.00005 | 0.00005 | 10.79 | 0.00005 | 0.00005 | 19.997 | 19.831 | 20.165 |
| 50 | 0.020 | 0.00005 | 0.00005 | 9.76 | 0.00005 | 0.00005 | 50.246 | 49.995 | 50.498 |
| 100 | 0.030 | 0.00005 | 0.00005 | 8.64 | 0.00005 | 0.00005 | 100.080 | 99.746 | 100.414 |

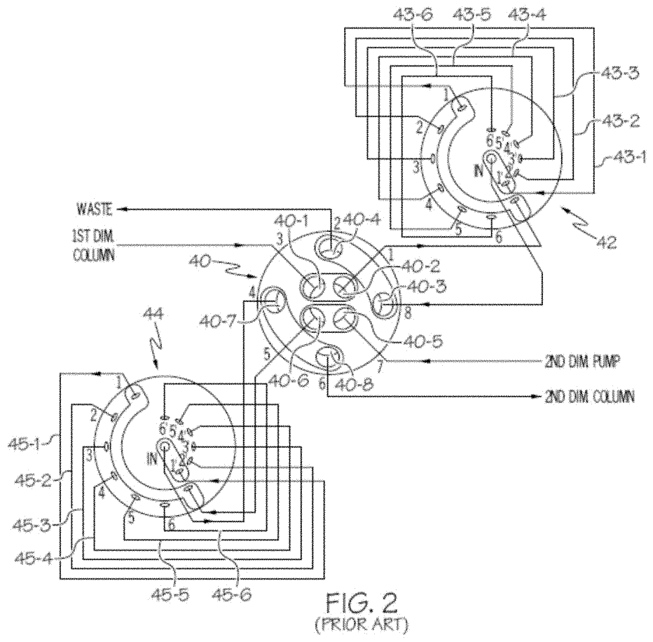

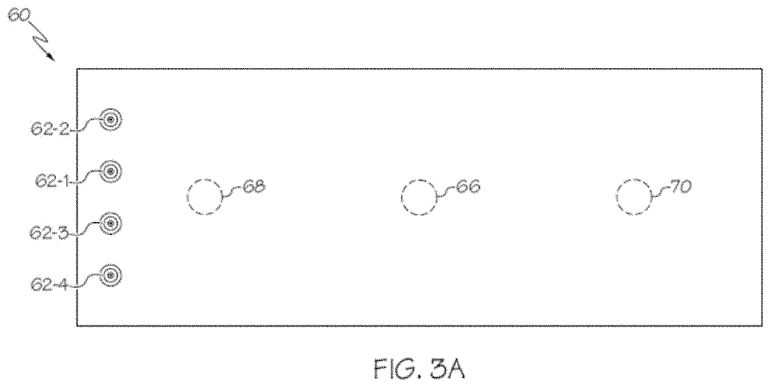

FIG. 2 shows a multi-valve array that is used to acquire samples from a chromatography system in a first chromatographic dimension and to inject these samples into a second chromatography system of a second chromatographic dimension. The configuration includes a first rotary valve 40 having eight fluid connections 40-1 to 40-8, a second rotary valve 42 associated with a first dimension chromatography system and having fourteen fluid connections 42-1 to 42-14, and a third rotary valve 44 associated with a second dimension chromatography system and having fourteen fluid connections 44-1 to 44-14.

The multi-valve array is shown in a state in which the system flow from the first dimension chromatography system is received at port 40-1 and exits through port 40-2 to the second valve 42. In this state, the system flow may contain a chromatographic peak such that the sample in the peak is loaded into an external sample loop 43-1 that is the active one of the six external sample loops 43-1 to 43-6. Alternatively, the second valve 42 may be switched so that only a portion of the sample in the peak is loaded into the external sample loop 43-1 and so another portion of the sample in the peak may be loaded into a different sample loop 43. Liquid displaced from the external sample loops 43 flows back to the first valve 40 at port 40-3 before exiting to waste through port 40-4. The second valve 42 may be switched at different times corresponding to the presence of the different chromatographic peaks so that a series of samples from the peaks, or sample slices of an individual peak, may be stored in the external sample loops 43.

The system flow of the second dimension upstream of the chromatographic column is received at the first valve at port 40-5 and flow from port 40-6 to the third valve 44 into one of six external sample loops 45-1 to 45-6 that can hold sample for injection into the second dimension chromatography system. The system flow displaces the sample stored in the external sample loop 45-1 that is part of the active flow path according to the current state of the third valve 44. The displaced sample is received at port 40-7 of the first valve 40 and exits at port 40-8 to flow to the chromatographic column of the second chromatography system. The third valve 44 may be switched to inject another one of the stored samples from the other external sample loops 45 into the second chromatography system.

The multi-valve array may be operated in a complementary state by reconfiguring the state of the first valve 40 so that the roles of the second and third valves 42 and 44 are reversed from that shown in the figure. In the complementary configuration, the system flow from the first dimension chromatography system is received at the third valve 44 which is used to sample chromatographic peaks, or portions of peaks, from the first chromatography system. The system flow of the second dimension is now managed by the second valve 42 which operates to inject samples previously stored into its external sample loops 43 into the flow to the chromatographic column for the second dimension.

To accommodate the fluid paths in the illustrated multi-valve array, eight fluid connections are used for the first valve 40 and 14 fluid connections are used for each of the second and third valves 42 and 44, for a total of 36 fluid connections. Typically, these connections are made using compression screws and ferrules. The large number of fluid connections results in a significant chance of leakage from at least one fluid connection.

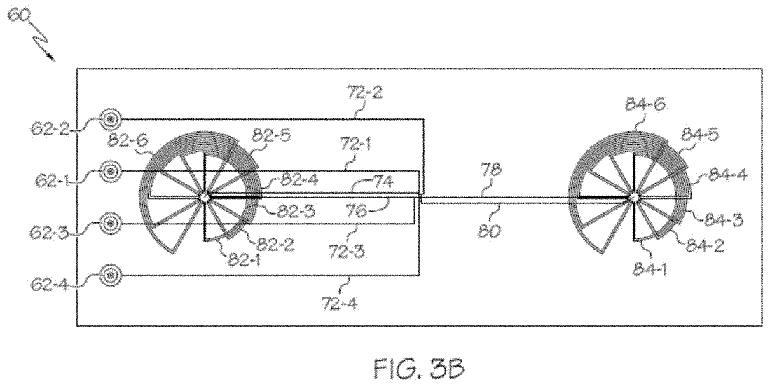

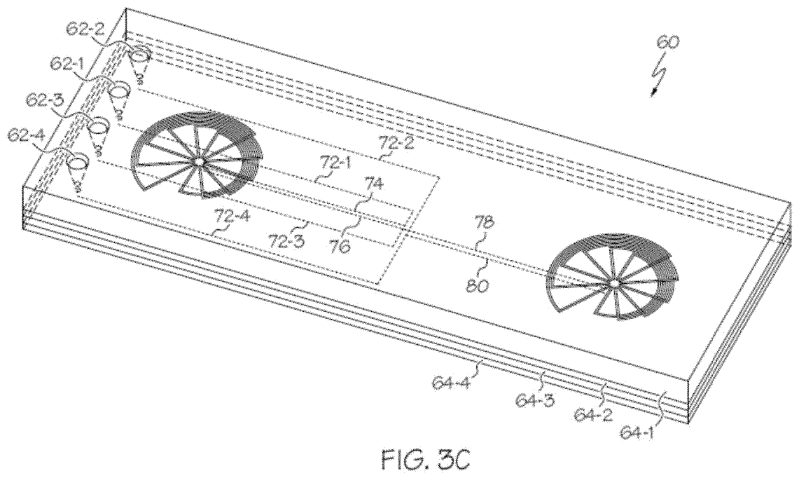

FIG. 3A shows a top view of an example of a stator body 60 that can be used as part of a multi-valve array that replaces the multi-valve array depicted in FIG. 2. As referred to below with respect to the figures, the top side of the stator body 60 (and other stator bodies described below) is the side which includes ports for coupling to external conduits and the bottom side includes stator surfaces to engage rotor surfaces of rotary valve actuators. FIG. 3B is a view of the stator body 60 similar to that of FIG. 3A; however, the material is depicted as transparent so that internal fluid channels are visible. FIG. 3C is a perspective view of the transparent stator body 60 shown in FIG. 3B; however, the four layers 64-1 to 64-4 used in the diffusion bonding process are depicted. It should be recognized that the discrete layers 64 are not distinguishable in the stator body 60 at the end of the diffusion bonding process. The description of the stator body 60 provided below references all views presented in FIGS. 3A to 3C.

The stator body 60 includes four ports port 62-1 to 62-4 which are functionally similar to certain ports of the first rotary valve 40 shown in FIG. 2. Specifically, port 62-1 corresponds to port 40-1, port 62-2 corresponds to port 40-4, port 62-3 corresponds to port 40-5 and port 62-4 corresponds to port 40-8.

The stator body 60 includes three stator surfaces 66, 68 and 70 each having multiple stator ports. The stator surfaces 66, 68 and 70 are disposed on an opposite side (bottom side) of the body 60 form the four ports 62 as shown by the dashed circles in FIG. 3A. When used as part of a two-dimensional chromatography system, one of the ports 62-1 is in fluid communication with the eluent from a chromatographic column in a first dimension chromatography system and another port 62-2 is an outlet port that is coupled to a waste fluid path. The third port 62-3 receives a system flow of a second dimension chromatography system upstream of the second dimension chromatographic column and the fourth port 62-4 is an outlet port that provides the system flow to the inlet of the second dimension chromatographic column.

Ports 62-1 to 62-4 are in fluid communication with the central stator surface 66 through inlet or outlet fluid channels 72-1 to 72-4, respectively. The central stator surface 66 is also in fluid communication with stator surface 68 through fluid channels 74 and 76, and with stator surface 70 through fluid channels 78 and 80.

The stator body 60 includes two sets of internal sample channels. One set includes six sample channels 82-1 to 82-6 associated with stator surface 68 and the other set includes six sample channels 84-1 to 84-6 associated with stator surface 70. Each sample channel 82, 84 includes two radial channel segments formed at a depth corresponding to the interface of layers 64-1 and 64-2. A first end of each radial channel segment is coupled, through a vertical channel segment, to a corresponding one of the stator surfaces 68 or 70. The second end of each radial channel segment is coupled, through a short vertical path, to one end of an arc-shaped channel segment (portion of a circumferential path). The arc-shaped channel segments are formed at a depth corresponding to the interface of layers 64-2 and 64-3. Thus, the full path of a sample channel is defined by two radial channel segments, an arc-shaped channel segment, two vertical channel segments to the two associated stator ports and two additional vertical channel segments that couple the arc-shaped segment to the two radial segments.

All the sample channels 82, 84 are machined to tight tolerances, for example, as listed in Table 2. Consequently, the sample channels have better volume accuracy than conventional external sample loops. Each of the sample channels 82, 84 can be formed of channel segments having a length, width and depth that are accurately controlled so that each sample channel can be made to have a volume that is substantially equal to the volumes of the other sample channels. The interchannel sample volume accuracy can be +/−1% which is an accuracy that cannot be achieved with external sample loops utilizing typical commercially-available tubing for plumbing liquid chromatography systems. Consequently, for a sample that fully loads each of the sample channels, the chromatographic measurement data are substantially the same regardless of which sample channel is used for sample injection.

To avoid interference in terms of intersecting channels, the fluid channels are formed at different interfaces of the four layers 64. For example, the lengths (i.e., non-vertical segments) of the fluid channels 72, 74, 76, 76 and 80 may be formed at the interface of layers 64-3 and 64-4. In alternative embodiments, the number of layers may differ. For example, for more complex multi-valve arrangements having additional stator surfaces, sample channels and/or external ports, additional layers may be used to accommodate a more complex fluid channel layout. Each fluid channel typically includes a short vertical segment at it ends to connect it to a port on one of the stator surfaces or one of the external ports 62. In addition, each sample channel includes a vertical segment that extends from one end of the arc-shaped segment through the intervening layer to one end of the radial segment. Vertical segments can be formed, for example, by drilling through one or more layers before diffusion bonding the layers together.

During operation, the system flow for the first dimension is received at port 62-1, flows through fluid channel 72-1 to the central stator surface 66 and back out of the stator body 60 through fluid channel 72-2 and port 62-2 to waste. The left valve is controlled such that the first dimension system flow is directed to one of the sample channels 82 for loading with a sample (e.g., peak slice) as the sample is detected or otherwise known to be present in the first dimension system flow, otherwise the system flow exits to waste. The right valve is controlled such that the second dimension system flow through fluid channel 72-3 is directed to one of the sample channels 84 to displace the contained sample into the system flow toward the second dimension chromatographic column. Thus, the left and right valves can be operated to perform sample loading for the first chromatographic dimension and sample injection into the second chromatographic dimension, respectively. The center valve can be switched to change which set of sample channels 82 or 84 is used for acquiring the first dimension samples and used for injecting previously acquired first dimension samples into the second dimension system flow.

In the embodiments described above with respect to FIGS. 3A to 3C, there are six sample channels for each set. It should be recognized that in alternative embodiments, the number of sample channels per set can be as few as one or any other number of sample channels that can be accommodated by the physical size of the device and the layout of the fluid channels.

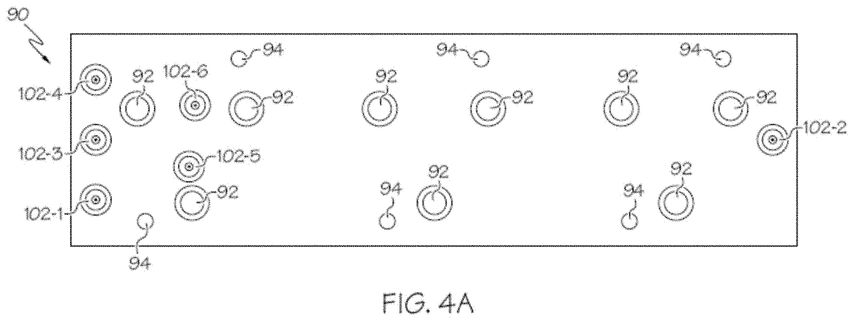

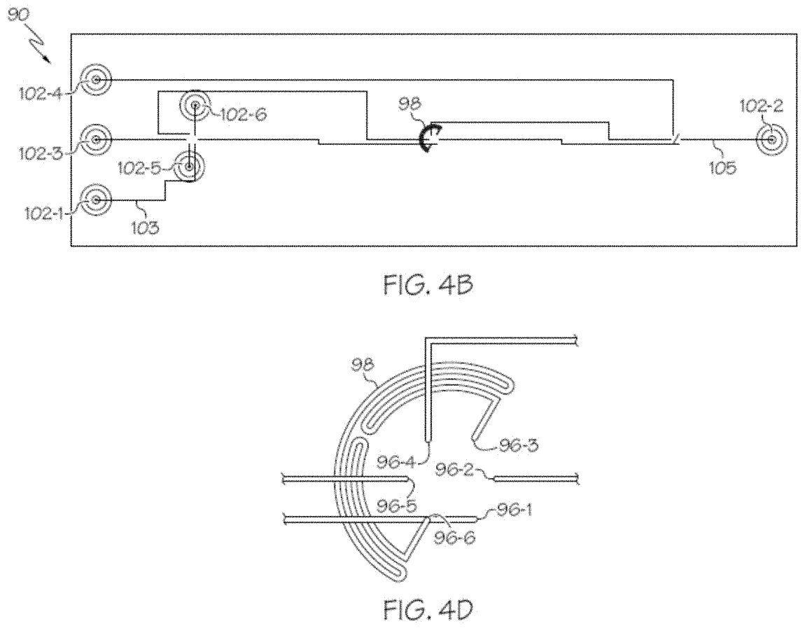

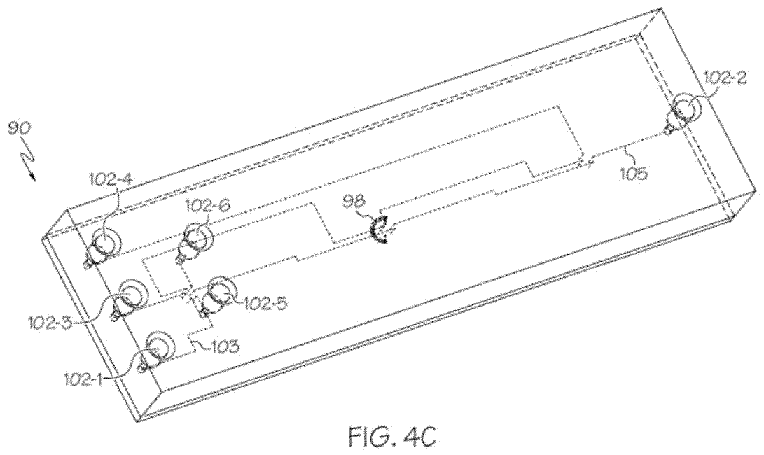

FIGS. 4A, 4B and 4C are a top view, transparent top view and transparent top perspective view, respectively, of an example of a stator body 90 that can be used as part of a multi-valve array for acquiring different volumes of sample for a chromatographic injection. Certain holes 92 and 94 are not shown in FIGS. 4B and 4C to improve the clarity of the remaining features in the figures. FIG. 4D is an expanded view of the central portion of FIG. 4B and shows how various internal fluid channels terminate at one of the stator ports 96-1 to 96-6. Also shown is a hybrid arc and serpentine layout to a fluid channel that couples stator ports 96-3 and 96-6.

As described above, the stator body 90 can be fabricated using a diffusion bonding process so that multiple fluid channels can be formed inside the body 90. By way of non-limiting examples of materials, the stator body 90 may be fabricated from one or more of titanium, stainless steel, and various types of ceramic materials and polymers.

The stator body 90 includes bolt holes 92 and alignment pin holes 94 used to attach each of three rotary valve actuators and rotors to a corresponding stator surface. Six ports (ports 102-1 to 102-6) are provided to conduct liquid to or from the stator body 90. Specifically, port 102-1 is at one end of a chromatography system inlet channel and is configured to receive a system flow (mobile phase) of a chromatography system and port 102-2 is at one end of a chromatography system outlet channel and is configured to provide an outlet for the system flow. Ports 102-3 and 102-4 are sample inlet and outlet ports, respectively, for a liquid flow containing a sample to be loaded into three distinct sample channels. Ports 102-5 and 102-6 allow for coupling of an external sample loop to the stator body 90. In alternative embodiments, there may be one or more additional ports to couple to additional external sample loops or ports 102-5 and 102-6 may be omitted.

The plurality of internal fluid channels inside the stator body 90 enables a multi-valve array to realize an improvement in performance relative to a typical valve configuration that uses only external sample loops. For example, unswept volumes corresponding to connections necessary for external couplings are reduced and therefore carryover and cross-contamination are also reduced. The sample channels formed in the stator body 90 enable dimensional and volume accuracies that are not achievable with external sample loops. Consequently, multiple internal sample channels of different volumes can be used instead of resorting to partial filling of external sample loops because the volumes of the internal sample channels and any external sample loops can cover a larger range of volumes than would be possible using partial sample loop filling. Table 3 shows nominal, minimum and maximum volumes associated with 1.0 μl and 2.0 μl sample channels that can be formed in a diffusion-bonded body, such as the illustrated stator body 90. The smaller manufacturing tolerances for ID and length result in significantly better control of the volume for small sample channels. Thus, a diffusion-bonded stator body can hold smaller sample volumes than external sample loops while having the additional advantage of more accurate volume control. Regardless, the stator body 90 can still allow the partial loop filing of an external sample loop (e.g., a sample loop connected at ports 102-5 and 102-6) or a large volume internal sample channel.

TABLE 3
AQUITY SAMPLE LOOPS

| Sample Loop | Nominal | | | Nominal | | | Nominal | Minimum | Maximum |
|---|---|---|---|---|---|---|---|---|---|
| Size (uL) | ID (in) | Tolerance+ | Tolerance− | Length (in) | Tolerance+ | Tolerance− | Volume (uL) | Volume (uL) | Volume (uL) |
| 1 | 0.008 | 0.00005 | 0.00005 | 1.22 | 0.001 | 0.001 | 1.0008 | 0.9875 | 1.0142 |
| 2 | 0.008 | 0.00005 | 0.00005 | 2.43 | 0.001 | 0.001 | 2.0016 | 1.9758 | 2.0275 |

The multi-valve array configured with the illustrated stator body 90 can be used as a sampling interface between an extraction system and a chromatographic system to perform an on-line extraction analysis permitting optimization of the extraction process. The array allows a sample to be acquired at one time and stored in different volumes for subsequent injections. As an extraction solvent passes through the multi-valve array, the extractant is sampled by directing it through one or more of the internal sample channels, or the external sample loop, in-line with the chromatographic system. The ability to select different volumes associated with the internal sample channels and any external sample loops can be used to address the amount of analytes in the extraction sample and the dynamic range of the chromatographic detector. More specifically, to quantitate or qualitatively compare analytes extracted from a sample, the signal from the chromatographic detector should be in a linear range of the detector. The multi-valve array can be used to acquire sample into multiple internal sample channels and external sample loops of different volume. This allows an operator to select the sample channel or loop having the appropriate volume to generate a signal in the linear range of the detector. For example, if a prior sample injected from one of the sample channels or loop resulted in an “off scale” detector signal, the sample stored in a smaller volume internal sample channel or external loop can be injected. Alternatively, if the prior sample resulted in too small a detector response, the sample stored in a larger volume internal sample channel or external loop can be injected.

The multi-valve array can be configured with different size sample channels and loops to accommodate different application modes. By way of non-limiting examples, an array used for small molecule applications can include a 10 nL internal sample channel, a 100 nL internal sample channel and a 1.0 μL external sample loop, and an array used for large molecule applications can include a 1.0 μL external sample loop, a 5.0 μL external sample loop and a 20.0 μL external sample loop.

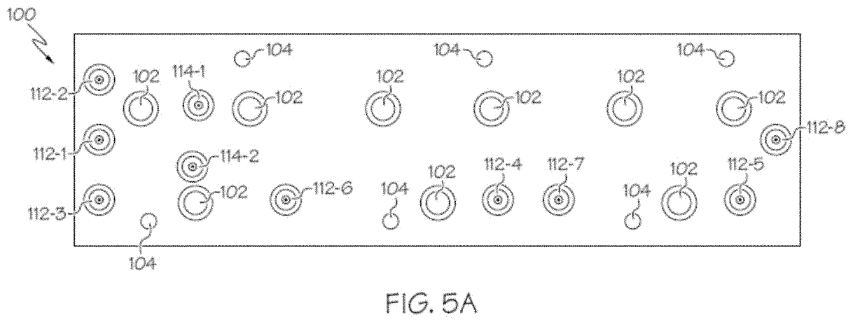

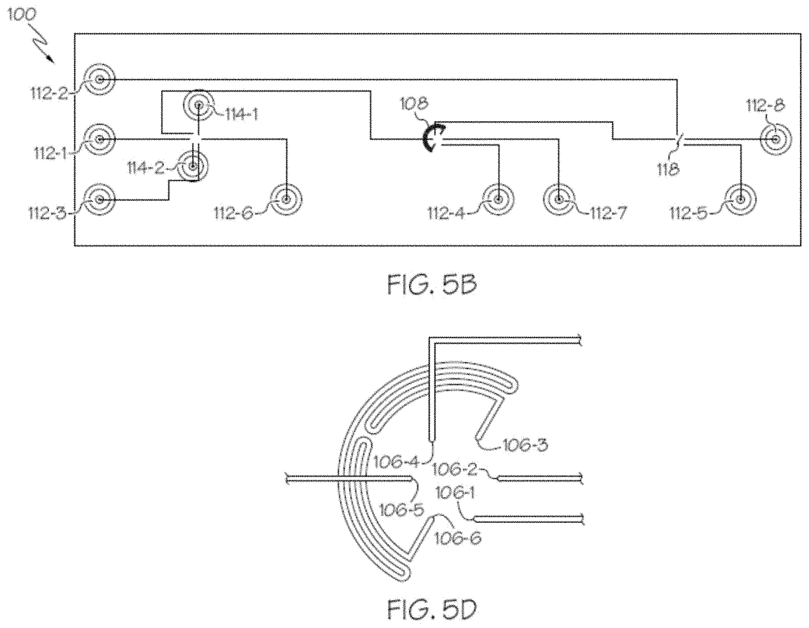

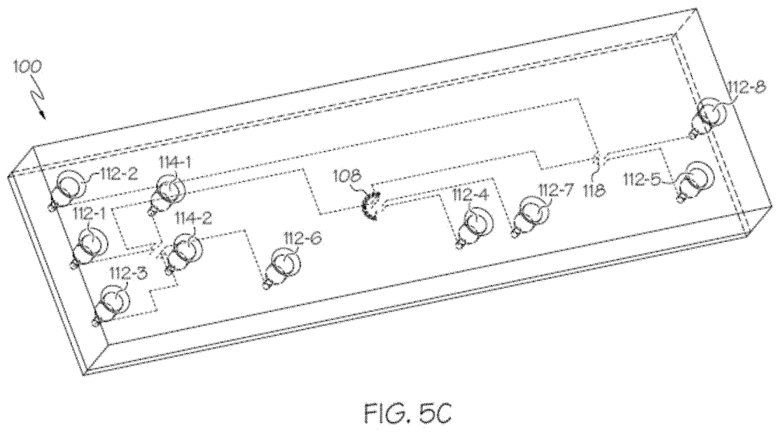

FIG. 5A is a top view, transparent top view and transparent top perspective view, respectively, of an example of a stator body 100 that can be used as part of a multi-system injector array. The transparent views show the body material as clear so that internal fluid channels and features are apparent. Certain holes 102 and 104 are not shown in FIGS. 5B and 5C to improve the clarity of the remaining features in the figures. FIG. 5D is an expanded view of the central portion of FIG. 5B and shows how internal fluid channels terminate at one of the stator ports 106-1 to 106-6. A fluid channel 108 that couples stator ports 106-3 and 106-6 has a serpentine arc shaped path.

The multi-system injector array can be used to acquire separate volumes of a sample for injection into multiple chromatography systems. For example, the sample may be acquired from a process line and stored in the separate volumes. This allows the sample to be analyzed by different chromatography systems so that multi-attribute information (e.g., information regarding the sample that cannot be obtained by a single chromatography system) can be acquired.

The stator body 100 may be fabricated using a diffusion bonding process such as those described above. The stator body 100 includes bolt holes 102 and alignment pin holes 104 used to attach each of three rotary valve actuators and rotors to a corresponding stator surface. The stator body 100 includes ten external ports. Ports 112-1 and 112-2 are inlet and outlet sample ports, respectively. Ports 112-3, 112-4 and 112-5 are inlet ports for receiving a system flow (mobile phase) from a first chromatography system, a second chromatography system and a third chromatography system, respectively. Ports 112-6, 112-7 and 112-8 are outlet ports for coupling to tubing that provides the system flows to the chromatographic columns of the first, second and third chromatography systems. In alternative embodiments, there may be a different number of inlet and outlet ports according to the number of chromatography systems used for analysis.

The stator body 100 includes a plurality of internal fluid channels that provide advantages similar to those for the above-described embodiments. In general, a single sample is loaded into multiple internal sample channels and/or external sample loops in one continuous sequence. In the illustrated embodiment, the sample can be loaded into three storage volumes: an external sample loop coupled to the stator body 100 at ports 114-1 and 114-2, an internal sample channel 116 formed beneath the stator surface for the center valve, and an internal sample channel 118 formed beneath the right stator surface. Once the sample is stored in the external sample loop, the left rotary valve can be switched to a state in which the sample is injected into the mobile phase of the first chromatography system. Similarly, once the samples are stored in the internal sample channels 108 and 118, the center and right rotary valves can be switched to states in which the samples are injected into the mobile phases of the second and third chromatography systems, respectively.

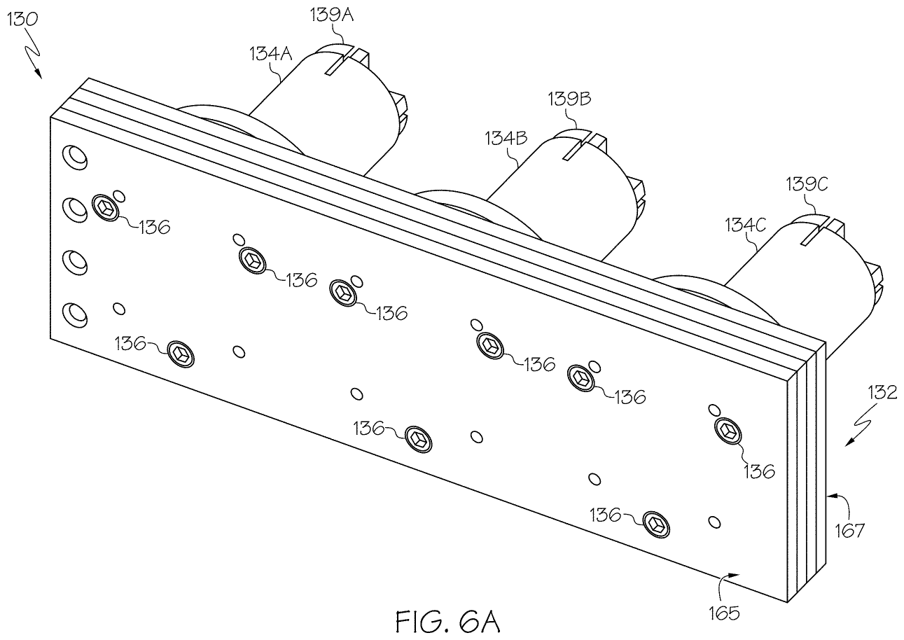

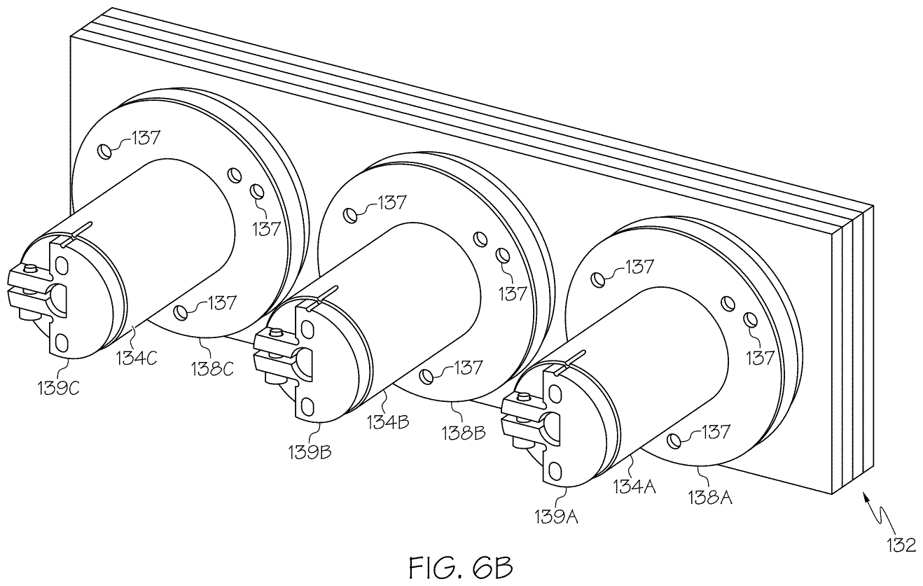

FIGS. 6A and 6B are a top back view and a top front view, respectively, of an example of a multi-valve array 130 which includes a stator body 132 such as those in the examples described above. The multi-valve array 130 also includes three rotary shear seal valve pods 134 secured to the stator body 132 by bolts 136 which engage threaded holes 137 in a flange 138 on each valve pod 134. In these and subsequent drawings, “A,” “B,” “C” and “D” used with reference numbers indicate the correspondence of other illustrated components to valve pods 134A, 134B, 134C and 134D, respectively. Internal components of each valve pod 134, such as clover springs, result in a force being applied to maintain each rotor surface against the corresponding stator surface on the stator body 132. A complete rotary shear seal valve includes a pod 132 and a valve drive (not shown). The valve drive has a rotatable drive shaft with features (e.g., alignment pins of different diameter) to engage, in a specific rotational orientation, a top end 139 of the pod 132 which is coupled to a pod shaft that rotates the rotor surface. The valve drive includes a motor and a gearbox mechanically coupled to the drive shaft.

In a conventional rotary shear seal valve, one or more screws or bolts are typically used to secure the valve pod to the valve drive to maintain the valve drive in engagement with the valve pod. In the illustrated example, the stator body 132 does not permit the use of screws or bolts for this purpose because the associated through holes in the stator body 132 could interfere with the internal fluidic channels.

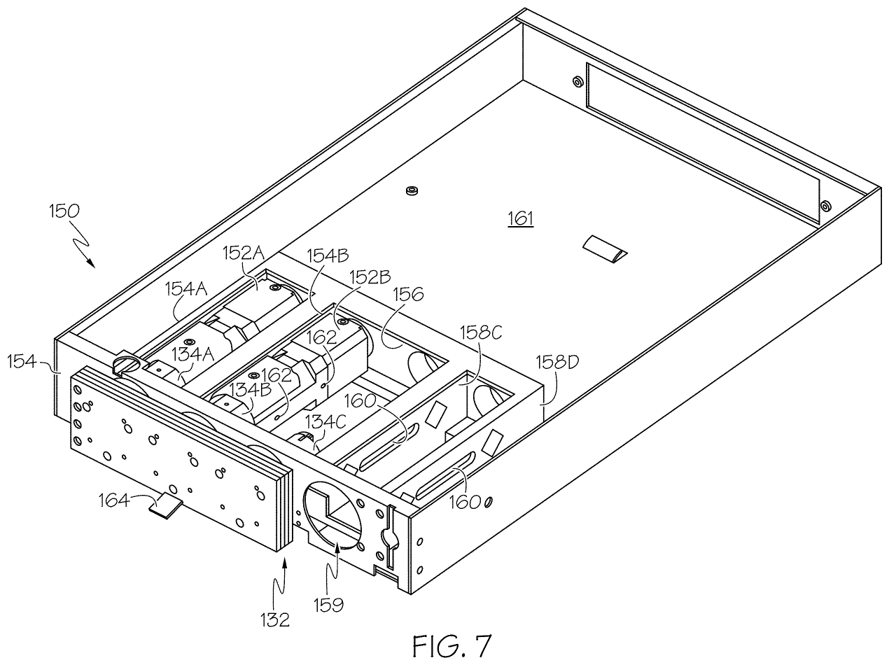

FIG. 7 shows a mounting assembly 150 that can be used with the multi-valve array to ensure proper engagement of the valve drives 152 with the valve pods 134. The figure shows only two complete rotary shear seal valves so that various features of the mounting assembly 150 are visible. A third valve pod 134C without a corresponding valve drive is shown attached to the stator body 132 and is visible to the right of the other two valve pods 134A and 134B. Unoccupied space for a fourth rotary shear seal valve that is independent of the stator body 132 is visible to the right of the third valve pod 134C.

The mounting assembly 150 includes a mounting frame having a front wall 154, a back wall 156 opposite to the front wall 154, and four side walls 158. The front wall 154 has four openings 159 (only one unoccupied) each configured to pass a portion of one of the valve pods 134. The side walls 158 extend perpendicularly between the front wall 154 and the back wall 156. Each side wall 158 has a slot 160 that extends along a portion of its length between the front and back walls 154 and 156. In the figure, the back wall 156 and side walls 158 are formed as a single element that is attached to a rack or tray 161 which includes the front wall 154; however, in other examples, the walls 154, 156, 158 may be individual wall structures or may be provided such that two or more walls are integrally formed.

A spring element (not shown) is disposed on or against the inside surface of the back wall 156 in a position opposite to one of the openings in the front wall 154. By way of non-limiting examples, the spring element may be a compression spring or other force-applying deformable element such as a pneumatic, magnetic or electromagnetic element. When one of the valve locations in the mounting assembly 150 is occupied by a valve pod 134 and valve drive 152, the spring element is compressed between the back end of the valve drive 152 and the back wall 156. The spring element urges the valve drive 152 forward, that is, in a direction away from the back wall 156 and toward the front wall 154 which in turn maintains the valve drive 152 in engagement with the respective valve pod 132 and pushes the valve pod 132 forward toward the front wall 154. A pair of guide screws (not shown) extending from threaded holes 162 on one of the sides of a valve drive 152 engages the slot 160 in an adjacent side wall 158. Only one slot 160 is used with each valve drive 152. More specifically, valve drive 152A is used with the slot in side wall 154A although side wall 154B is also adjacent. Valve drive 152B is used with the slot in sidewall 154B, and the slots 160 in side walls 154C and 154D are available for two additional valve drives (not shown). During assembly, each valve drive 152 is substantially restricted by its slot 160 and engaged screws to movement in a direction parallel to the slot length, that is, in a direction parallel to the valve pod axes and valve drive axes. The screws may be shoulder screws. For example, each screw may have an unthreaded portion along a length beneath the screw head where the screw passes through the slot 160 where the unthreaded length is greater that a thickness of the side wall 154. This configuration allows the valve drive 152 to move along a linear path as it engages the valve pod 132. The slot 160 may be dimensioned such that its vertical dimension is greater than a diameter of the unthreaded portion of the screw by an amount that provides a small vertical gap to allow easier engagement of the valve pod 132 to the valve drive 152.

A retainer element 164 is used to secure the stator body 132 against the front (external) surface of the front wall 154 while the spring element is under compression. In some examples, the retainer element 164 is a flexible component that extends away from the front wall 154 and may be pushed downward. When released, the retainer element 164 moves toward its original position.

During assembly, the valve drives 152 are positioned in their proper locations adjacent the side walls 158 and the spring elements. The retainer element 164 is pushed downward to allow the stator body 132 with its attached valve pods 134 to be positioned so that a portion of each valve pod 134 extends through a corresponding opening 159 in the front wall 154 and engages a valve drive 152. The retainer element 164 is then released so that it moves toward its original position and comes in contact with the bottom surface 165 of the stator body 132. The retainer element 164 applies force to the stator body 132 so that its top surface 167 is in contact with the front wall 154 while the spring element forces the valve drive 152 to engage the valve pod 134. In this manner, the stator body 132, valve drives 152 and valve pods 134 are securely held in their proper operating positions.

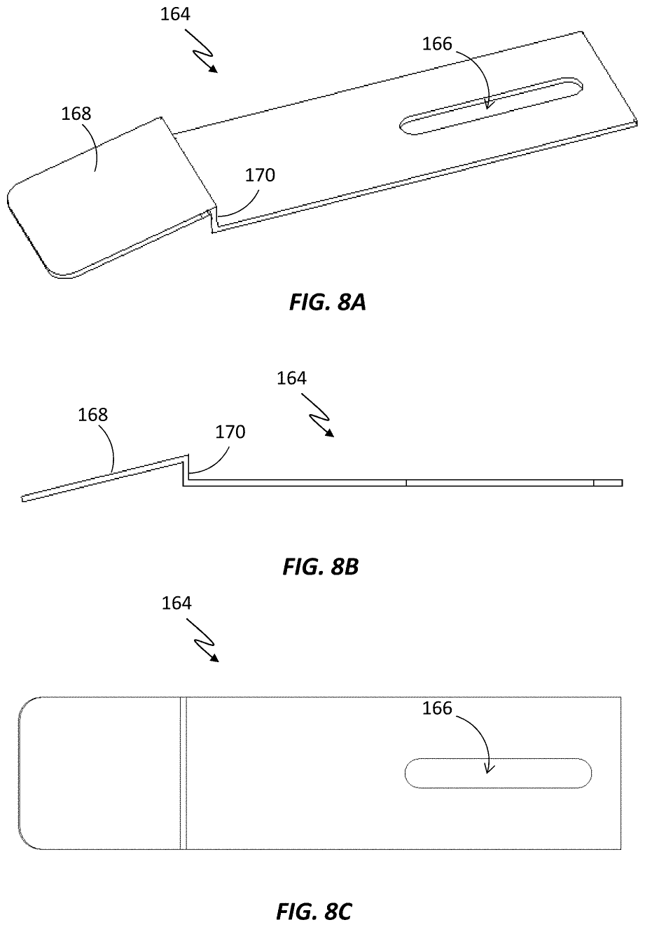

In one example, the retainer element 164 is a sprint clip formed of a resilient material and shown in more detail in the perspective, side and top views provided in FIGS. 8A, 8B and 8C, respectively. The retainer element 164 may be attached to the mounting assembly by two screws. Each screw passes through an elongate opening 166 and engages a threaded hole on the bottom side of the front wall 154. The retainer element 164 is adjusted by sliding in a direction along the length of the opening 166 to a desired position before tightening the bolt. During installation, the front lip 168 is continually depressed downward to allow the stator body 132 to pass and be placed in proper position against the front wall 154. Once in place, the front lip 168 is released so that the retainer element 164 returns to approximately its original shape and an engagement edge 170 comes into contact with and applied force to the front surface of the stator body 132.

In alternative examples, the retainer element can take on any of a wide variety of other forms. The dimensions and shape of the retainer element vary and are determined based on application of a desired force over a contact area. In other examples, two or more retainer elements are used to apply force against the stator body 132 at multiple locations. Other means for applying a holding force to the stator body 132 may be used. For example, one or more toggle clips or friction devices may be used. Alternatively, a deformable material, such as a deformable polymer, may be used.

The examples of mounting assemblies described above accommodate the various examples of stator bodies. Advantageously, the mounting assembly provides a quick and reliable means to secure a stator body so that the attached valve pods properly engage their valve drives without the need for tools or any complicated alignment procedures. Similarly, removal of the stator body with its attached valve pods from the mounting assembly is easily accomplished.

In alternative examples, various types of adaptors may be used with a valve drive and configured for use as described above. For example, a valve drive manufactured for use with a different type of valve pod may be used with an adaptor to engage and properly register with the internal components of the valve pod, as described in U.S. patent application No. 62/695,473, titled “Adapting Valves” and filed Jul. 9, 2018, and incorporated by reference herein in its entirety.

The arrangement of stator surfaces and valve pods is not limited to those described above. In other alternative examples, the multi-valve array may include a stator array that has stator surfaces for only two valve pods or the stator array may have a number of stator surfaces sufficient to allow attachment of four or more valve pods. Moreover, the multi-valve array may be a two-dimensional array. For example, the array can be an arrangement of two or more rows where each row includes two or more valves. Alternatively, the stator body may be configured for other two-dimensional array configurations such as a triangular arrangement of valves.

While the invention has been shown and described with reference to specific embodiments, it should be understood by those skilled in the art that various changes in form and detail may be made therein without departing from the scope of the invention as recited in the accompanying claims.

1. A stator array comprising a stator body having a first stator surface and a second stator surface separated from the first stator surface, each of the first and second stator surfaces configured to engage a rotor surface of a rotary valve and having a plurality of stator ports, the stator body having a first fluid channel inside the stator body, the first fluid channel coupling one of the stator ports of the first stator surface to one of the stator ports of the second stator surface.

2. The stator array of claim 1 wherein the stator body has an external surface separated from the first and second stator surfaces and a second fluid channel coupling a port on the external surface to one of the stator ports of one of the first and second stator surfaces.

3. The stator array of claim 1 wherein the first fluid channel is a microfluidic channel.

4. The stator array of claim 1 wherein the stator body comprises a plurality of diffusion bonded layers.

5. The stator array of claim 4 wherein the stator body has a plurality of fluid channels each defined in a diffusion bonded layer and wherein one of the fluid channels is in a diffusion bonded layer that is different from the diffusion bonded layer of at least one of the other fluid channels.

6. The stator array of claim 4 wherein the stator body has a plurality of fluid channels and wherein at least one of the fluid channels is defined in at least two diffusion bonded layers.

7. The stator array of claim 1 further comprising:
a first rotary valve actuator having a first rotor surface abutting the first stator surface: and
a second rotary valve actuator having a second rotor surface abutting the second stator surface.

8. A stator array comprising a stator body having a plurality of internal fluid channels comprising a plurality of first sample channels, a plurality of second sample channels, a first and a second inlet channel, and a first and a second outlet channel, the stator body having a first stator surface, a second stator surface and third stator surface each having a plurality of stator ports, each of the first sample channels coupling one of the stator ports of the second stator surface to another one of the stator ports of the second stator surface, each of the second sample channels coupling one of the stator ports of the third stator surface to another one of the stator ports of the third stator surface, the first inlet channel and the first outlet channel each coupling one of the stator ports of the second stator surface to one of the stator ports of the first stator surface, the second inlet channel and the second outlet channel each coupling one of the stator ports of the third stator surface to one of the stator ports of the first stator surface.

9. The stator array of claim 8 further comprising a first dimension outlet channel, a second dimension inlet channel, a second dimension outlet channel and a waste channel each inside the stator body and each coupling a stator port of the first stator surface to an external port on the stator body.

10. The stator array of claim 8 further comprising:
a first rotary valve actuator having a first rotor surface abutting the second stator surface; and
a second rotary valve actuator having a second rotor surface abutting the third stator surface.

11. The stator array of claim 10 wherein the first and second rotary valve actuators are rotary shear seal valve actuators.

12. The stator array of claim 10 further comprising a third rotary valve actuator having a third rotor surface abutting the first stator surface.

13. The stator array of claim 8 wherein the stator body comprises a plurality of diffusion bonded layers.

14. The stator array of claim 8 wherein each of the first and second sample channels has a volume that is equal the volume of each of the other first and second sample channels.

15. A stator array comprising a stator body having a plurality of internal fluid channels, an external surface, a first stator surface having a plurality of stator ports and a second stator surface having a plurality of stator ports, the plurality of internal fluid channels comprising a chromatography system inlet channel coupling one of the stator ports of the first stator surface to a first external port on the external surface, a chromatography system outlet channel coupling another one of the stator ports on the first stator surface to a second external port on the external surface, a first sample loop coupling a first pair of the stator ports of the first stator surface, a second sample loop coupling a second pair of stator ports on the second stator surface, and a sample channel coupling one of the ports of the first stator surface to one of the ports of the second stator surface, wherein the sample channel conducts a sample between the first and second stator surfaces during a sample load operation.

16. The stator array of claim 15 further comprising:
a first rotary valve actuator having a first rotor surface abutting the first stator surface; and
a second rotary valve actuator having a second rotor surface abutting the second stator surface.

17. The stator array of claim 16 wherein the first stator surface and the first rotary valve actuator are configured as a first rotary shear seal valve and wherein the second stator surface and the second rotary valve actuator are configured as a second rotary shear seal valve.

18. The stator array of claim 15 wherein the stator body comprises a plurality of diffusion bonded layers.

19-32. (canceled)
